(19) United States
(12) Patent Application Publication
(10) Pub. No.: US 2020/0019925 A1
(43) Pub. Date: Jan. 16, 2020

(54) SYNCHRONOUS DELIVERY SYSTEM

(71) Applicant: EUROZEX LLC, Sarasota, FL (US)

(72) Inventor: Tokhir Tokhtabaev, Bradenton, FL (US)

(21) Appl. No.: 16/507,804

(22) Filed: Jul. 10, 2019

Related U.S. Application Data
(60) Provisional application No. 62/696,361, filed on Jul. 11, 2018.
(60) Provisional application No. 62/772,140, filed on Nov. 28, 2018.

(51) Int. Cl. G06Q 10/08; G08G 5/00; B64C 39/02; B64D 9/00; G07C 9/00

(52) U.S. Cl. CPC G06Q 10/0832; G06Q 10/08355; G08G 5/003; B64C 39/024; B64C 2201/042; G07C 9/00896; G06Q 10/0833; B64C 2201/128; B64D 9/00

(57) ABSTRACT

A method and system for pickup and delivery of parcels. The system includes a fleet of lockbox-equipped vehicles and a fleet of drones coordinated by back-end logistics software and a corresponding application (“app”) which runs on users' mobile devices. A customer who wishes to send a package uses the app to schedule package pick-up. The customer enters the package destination in the app, and a QR code is provided in the app on the customer's smart phone. One of the lockbox-equipped vehicles, human-driven or autonomous, responds to the pick-up request and drives the vehicle to the customer's location. The lockbox scans the QR code and opens a compartment to allow the customer to place the package inside. Logistics calculations are performed on a back-end server to determine the most efficient routing of the package, whether by driving or by drone flight, and the package is delivered accordingly.

### CROSS-REFERENCE TO RELATED APPLICATIONS

This application claims the benefit of the priority date of U.S. Provisional Patent Application Ser. No. 62/696,361, titled SYNCHRONOUS DELIVERY SYSTEM, filed Jul. 11, 2018 and U.S. Provisional Patent Application Ser. No. 62/772,140, titled SYNCHRONOUS DELIVERY SYSTEM, filed Nov. 28, 2018.

### BACKGROUND

### Field

The present disclosure relates generally to a parcel delivery network and, more particularly, to a method and a network of devices for pickup and delivery of parcels which includes a fleet of lockbox-equipped vehicles and a fleet of drones coordinated by back-end logistics software and a corresponding application which runs on users' mobile devices.

### Discussion

Consumer preferences have shifted away from shopping at malls and big box stores, and toward shopping over the Internet. Even grocery shopping is now being done over the Internet, and this trend for all types of shopping is expected to continue to accelerate. This dramatic increase in Internet shopping has led to a corresponding increase in demand for package delivery services. Although the traditional package delivery companies have responded with increased capacity, there is still a need for improved package pick-up and delivery services, including making it convenient for a sender to have a package picked up, and especially for parcels which can be or must be delivered immediately.

At the same time, drones have been developed and optimized which exhibit extremely stable and reliable flight characteristics, have reasonable payload carrying capability, and can be remotely commanded and/or pre-programmed to navigate and fly virtually anywhere. Furthermore, the advent of the “gig-based” economy has resulted in large numbers of vehicle owners who are willing to engage in part-time driving employment which can be initiated and controlled by simply using a smart phone application (“app”).

There is now an opportunity to combine the technological capabilities of drones with an app-coordinated fleet of drivers to meet the demand for fast and efficient package delivery services.

### SUMMARY

In accordance with the teachings of the present disclosure, a method and system for pickup and delivery of parcels are disclosed. The system includes a fleet of lockbox-equipped vehicles and a fleet of drones coordinated by back-end logistics software and a corresponding application (“app”) which runs on users' mobile devices. A customer who wishes to send a package uses the app to schedule package pick-up. The customer enters the package destination in the app, and a QR code is provided by the app on the customer's smart phone. A driver of one of the lockbox-equipped vehicles sees the pick-up request in the app and drives the vehicle to the customer's location. The vehicle may also be a driverless autonomous vehicle equipped with the lockbox. The lockbox scans the QR code and opens a compartment in the lockbox to allow the customer to place the package inside. Logistics calculations are performed on a back-end server to determine the most efficient routing of the package, whether by driving or by drone flight. A fleet of drones in communication with the back-end server, along with a fleet of the lockbox-equipped vehicles, are used to transport the package to the destination.

Additional features of the presently disclosed methods and devices will become apparent from the following description and appended claims, taken in conjunction with the accompanying drawings.

### BRIEF DESCRIPTION OF THE DRAWINGS

FIG. 1 is a schematic diagram showing the main elements of a synchronous delivery system, according to embodiments of the present disclosure;

FIG. 2A is a top-view illustration of a lockbox-equipped vehicle, according to an embodiment of the present disclosure;

FIG. 2B is a side-view illustration of a customer dropping off a package to the lockbox-equipped vehicle, according to an embodiment of the present disclosure;

FIG. 3 is an isometric view illustration of the lockbox shown in FIGS. 2A and 2B, according to an embodiment of the present disclosure;

FIG. 4 is a top view illustration of drone and vehicle routing in the synchronous package delivery system, according to an embodiment of the present disclosure;

FIG. 5 is a flowchart diagram of a method for pick-up and delivery of packages using a fleet of lockbox-equipped vehicles and a fleet of drones, according to an embodiment of the present disclosure;

FIG. 6A is a top plan view of the lockbox shown in FIG. 3;

FIG. 6B is a front elevational view of the lockbox of FIG. 3;

FIG. 6C is a side elevational view of the lockbox of FIG. 3;

FIG. 6D is a perspective view of the lockbox of FIG. 3;

FIG. 7 is a fragmentary perspective view of the lockbox of FIG. 3 showing a lock and a sensor system; and

FIG. 8 is an enlarged fragmentary perspective view of the latch of the lockbox of FIG. 3.

### DETAILED DESCRIPTION OF THE EMBODIMENTS

The following discussion of the embodiments of the disclosure directed to a synchronous delivery system is merely exemplary in nature, and is in no way intended to limit the disclosed devices or their applications or uses.

As discussed above, there is a need for a more efficient package delivery service—particularly for immediate pick-up and rapid delivery of packages. Traditional delivery services fulfill the need for long-range shipping (i.e., across the country, or internationally), but these traditional delivery services require a customer to take their package to a brick-and-mortar drop-off location, or schedule a home pick-up a day or more in advance. Furthermore, the traditional delivery services base their operations on filling up trucks with packages, driving the trucks to a warehouse, re-loading the packages onto different trucks based on final package destination, etc. This operational model means that most packages take two days or more to reach their destination, and overnight service is the best that can be achieved.

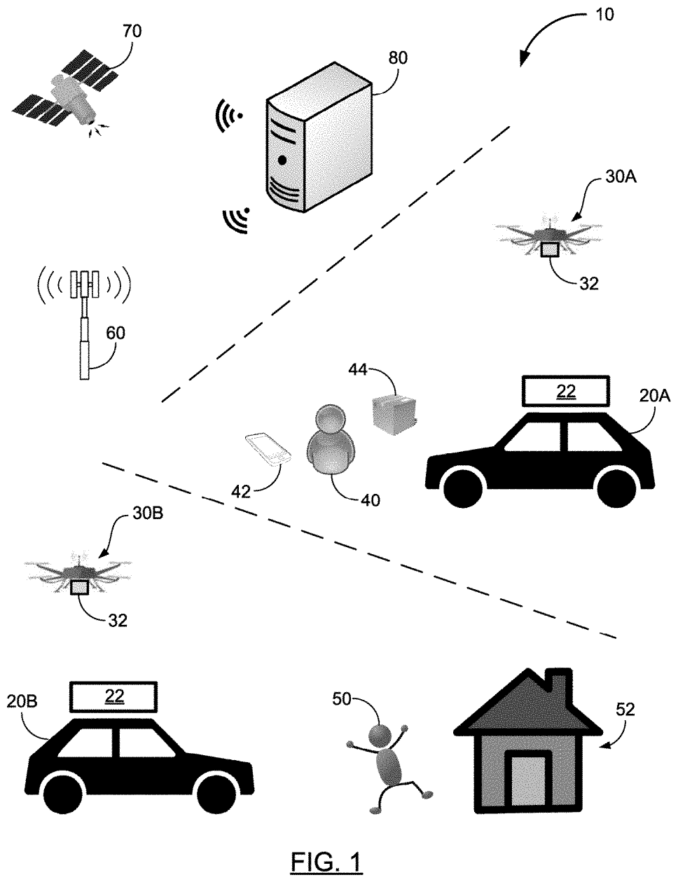

FIG. 1 is a schematic diagram showing the main elements of a synchronous delivery system 10, according to embodiments of the present disclosure. The synchronous delivery system 10 overcomes the limitations of traditional delivery services and enables fast, efficient package delivery on demand. The terms “package” and “parcel” are used generically throughout this disclosure to represent any item which needs to be delivered from one location to another. The package may be anything from a simple letter envelope, to a large business envelope, to a box or bag containing a shipped item.

The delivery system 10 includes a fleet of vehicles 20 (vehicles 20A and 20B shown), each including a lockbox 22 mounted thereupon. The lockbox 22 is shown as being mounted on the roof of the vehicles 20, but could as easily be mounted in the bed of a pickup truck, on the trunk of the vehicle 20, or other location, for example. As used herein, the vehicle 20 can be any type of transportation apparatus such as a truck, a car, a van, a motorcycle, a bicycle, or other apparatus as desired. The lockbox-equipped vehicles 20 may be driven by drivers who wish to be compensated for their participation, and are used to pick up and deliver parcels and packages, as discussed in detail below. The vehicles 20 may also be driverless autonomous vehicles whose movements are coordinated by algorithms and communication system infrastructure which are part of the synchronous delivery system 10.

The delivery system 10 also includes a fleet of drones 30 (drones 30A and 30B shown), each capable of carrying at least one package 32. As used herein, a drone can be any type of air, water, or land vehicle capable of carrying a package and can be remotely controlled or self-guided or otherwise controlled. The drones 30 are equipped with a communication and navigation system enabling each of the drones 30 to receive individual instructions to fly to a particular location, rendezvous with one of the lockbox-equipped vehicles 20, and pick up or drop off the package 32 to/from the vehicle 20.

A customer 40 who wishes to have a package 44 picked up and delivered to a destination begins by using an app or system called QWQER on his or her smart phone 42 or other communication device or controller capable of receiving input from the customer such as a computer, QWQER controller, GPS device, or other device. When the customer 40 uses QWQER to request a package pick-up, QWQER knows the location of the customer 40 based on cellular network signal triangulation, WiFi network affiliation, GPS data available from the smart phone 42, or some other technology. QWQER posts an available package pick-up opportunity for drivers of the fleet of lockbox-equipped vehicles 20. Meanwhile, the customer 40 enters, in the QWQER app, the destination to which the package 44 is to be delivered. The customer may also be asked to enter other information about the package 44, such as the size (dimensions) and approximate weight, for example. The QWQER app then provides a unique QR code or other unique identifier to the smart phone 42 of the customer 40.

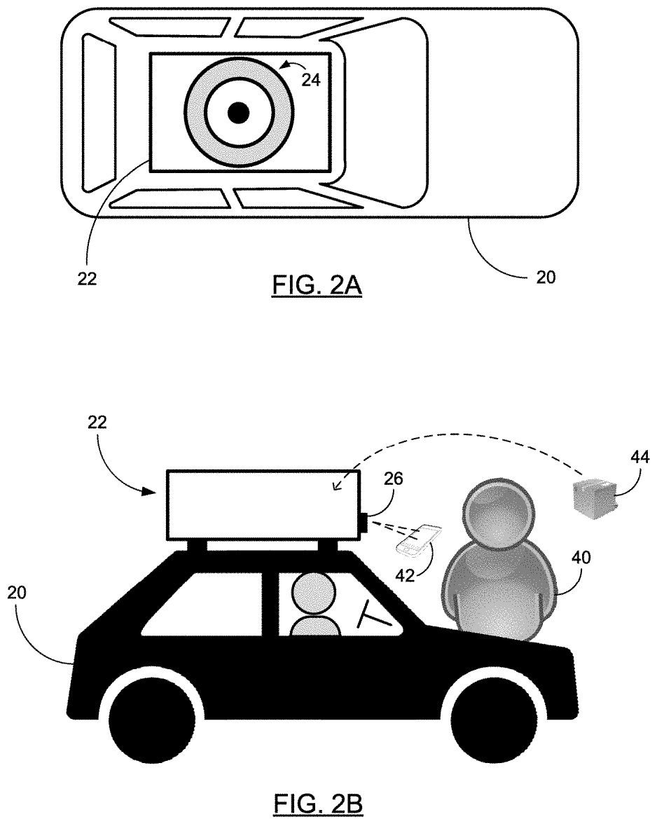

A driver of one of the lockbox-equipped vehicles 20 who is nearby the location of the customer 40 can accept the pick-up job in the QWQER app on the driver's smart phone or mobile device. The driver is then given routing directions to the customer's location in the QWQER app, in a manner similar to ride-hailing apps commonly in use. When one of the lockbox-equipped vehicles 20 arrives at the customer's location, the customer 40 allows the QR code on the smart phone 42 to be scanned by a scanner 26 (shown in FIG. 2B) on the lockbox 22. The lockbox 22 then opens a compartment to allow the customer 40 to place the package 44 inside the lockbox 22. It is understood the lockbox 22 can have a single compartment or multiple compartments as desired. If multiple compartments are provided, it is further understood that each of the compartments may include a separate lock to control access to each of the compartments. This ends the involvement of the package-sending customer 40.

The package 44 may be transported from its origination point to its destination point by any combination of the vehicles 20 and the drones 30. For example, the sending customer 40 may drop off the package 44 at the vehicle 20A as discussed above, and the drone 30A could then land on the vehicle 20A, have the package 44 (or package 32) affixed thereto by the driver of the vehicle 20A, and then the drone 30A could fly the package 44 to its destination. One of the drones 30 may be automatically dispatched to one of the vehicles 20 by the QWQER system based on optimal package routing calculations, or a driver of one of the vehicles 20 may request a drone to be dispatched using a request function in the QWQER app. Any other combination of vehicle and drone transport is possible, based on optimal logistics calculations, as discussed further below. In all cases, the QWQER system knows the location of the vehicles 20 (and the corresponding lockbox 22) and the drones 30 based on GPS data and communication capabilities thereof. The QWQER system also knows which of the vehicles 20 or the drones 30 has possession of each individual package 44 at all times, as each hand-off or transfer operation is recorded in the QWQER system.

A customer 50 who is expecting to receive a package does not need to take any action, other than to use the QWQER app, if desired, to check on the location and delivery status of the package. The customer 50 is shown in FIG. 1 as being at a home 52, which in this case represents the destination location for the package. Of course, the destination location could be someplace other than a house. For example, the destination or delivery location for a package could be an office or other type of building having a fixed street address, or could even be a person whose location is known only by their cell phone signal, where this variable location is tracked via the QWQER app.

In situations where the package 32 (or 44) is transported by drone, one method of package delivery to the customer 50 involves dispatching both the drone 30B and the lockbox-equipped vehicle 20B to the location of the home 52, where both the drone 30B and the vehicle 20B are coordinated by the QWQER app to arrive at about the same time. At this point, the drone 30B is commanded to land upon the lockbox 22 and release the package 32. The driver of the vehicle 20B then delivers the package 32 to the customer 50. Alternately, the drone 30B could rendezvous with the vehicle 20B at a location other than (preferably nearby or along the vehicle's route to) the home 52, whereupon the package 32 would be placed in the lockbox 22 by the driver, the lockbox-equipped vehicles 20B would be driven to the home 52, and the package 32 would be removed from the lockbox 22 by the driver and delivered to the customer 50. Which of the two delivery scenarios for drone-flown packages, described above, is used in a particular situation is dependent upon the overall logistics environment (where the vehicles 20 and the drones 30 are located, and where they need to go based on the package pick-up and delivery schedule). This is also discussed further below.

There are also situations where drone flight is not necessary, and the package 44 may be driven by one or more vehicles 20 from its origination point to its destination. In this type of situation, the driver of the vehicle 20B could also be routed directly to the delivery location alone, whereupon the package-receiving customer 50 may remove the package 44 from the compartment of the lockbox 22. The driver of the vehicle 20B could open the lockbox 22, or the customer 50 may have a QR code provided in the QWQER app which is scanned by and triggers opening of the lockbox 22. This latter scenario eliminates the need for a driver to open the lockbox 22, and facilitates the use of autonomous vehicles for the vehicles 20.

As mentioned, the drivers and customers use the QWQER app on their mobile devices, such as the smart phone 42 of the customer 40. The mobile devices typically communicate at least on a cellular communications network, including a plurality of cellular communication towers 60. The mobile devices may also communicate via Wi-Fi on wireless networks which are available in many buildings and other locations, where these wireless networks have Internet connectivity via communications—such as cable, DSL, fiber optic, satellite, etc.—provided by an Internet service provider. One or more satellites 70—such as communication satellites and/or GPS satellites—may also be involved in communication with the drones 30 and the QWQER app running on the mobile devices used by the customers 40 and the drivers of the lockbox-equipped vehicles 20.

A server 80 runs the back-end portion of the QWQER app. The server 80 communicates with the vehicles 20, the drones 30 and the QWQER app running on the mobile devices by way of the cell towers 60, the satellites 70, and other Internet connectivity over local area and wide area networks, as described above. Other technologies—such as DSRC, RF communications, etc.—may also be used to allow the server 80 to communicate with and know the location of the drones 30. The server 80 may be a single physical device, a cluster of devices operating as a server entity, or may simply represent cloud-based serving of the QWQER app, as would be understood by one skilled in the art.

The server 80 performs at least the following functions in managing the synchronous package delivery system;
Receive request for package pick-up from the customer 40, including tracking the location of the customer 40, collecting information about the package 44, and collecting the destination location for the package 44
Provide QR code to the smart phone 42 of the customer 40
Communicate cost of the package delivery to the customer 40, and collect payment via any suitable form of electronic payment
Coordinate the location of all of the lockbox-equipped vehicles 20 which are currently “online” and available for pick-up and drop-off (delivery) jobs
Broadcast available pick-up and drop-off jobs in the QWQER app
Manage each transaction where a driver accepts a pick-up or delivery job, including providing customer location navigation instructions to the driver, and coordinating payment to the driver for the job
Perform real-time logistics calculations including routing of all packages from their pick-up location to their delivery location, and location and routing of all of the lockbox-equipped vehicles 20 and the drones 30 to accomplish the package delivery
Coordinate the location of all of the drones 30 which are currently in service, along with the package delivery routing of the drones 30 and planned stops at lockbox-equipped vehicles 20 for recharging or battery exchange
Communicate navigation instructions and other instructions (such as landing, releasing a package, picking up a package, etc.) to each of the drones 30
Record the delivery of each package to the receiving customer 50 at the destination

FIG. 2A is a top-view illustration of a lockbox-equipped vehicle 20, according to an embodiment of the present disclosure. The lockbox-equipped vehicles 20 has mounted on its roof one of the lockboxes 22, as described previously. The lockboxes 22 have one or more standard designs, discussed below, including the features required for the package delivery system disclosed herein. It is anticipated that the lockboxes 22 are company-owned or company-proved equipment, and are leased or otherwise used by the drivers of the vehicles 20.

The lockbox 22 has a landing pad 24 on its top surface, as seen in FIG. 2A. The landing pad 24 has a visual identification feature (a “target” appearance) which enables positive identification and reliable landing flight control by the drones 30. The landing pad 24 is shown in FIG. 2A as being a simple set of concentric circles, but the landing pad 24 could include any other shapes or symbols as desired to provide a uniquely identifiable visual feature. The symbol on top of the landing pad 24 could be a large QR code which may be scanned by the drone 30 and which identifies the vehicle 20.

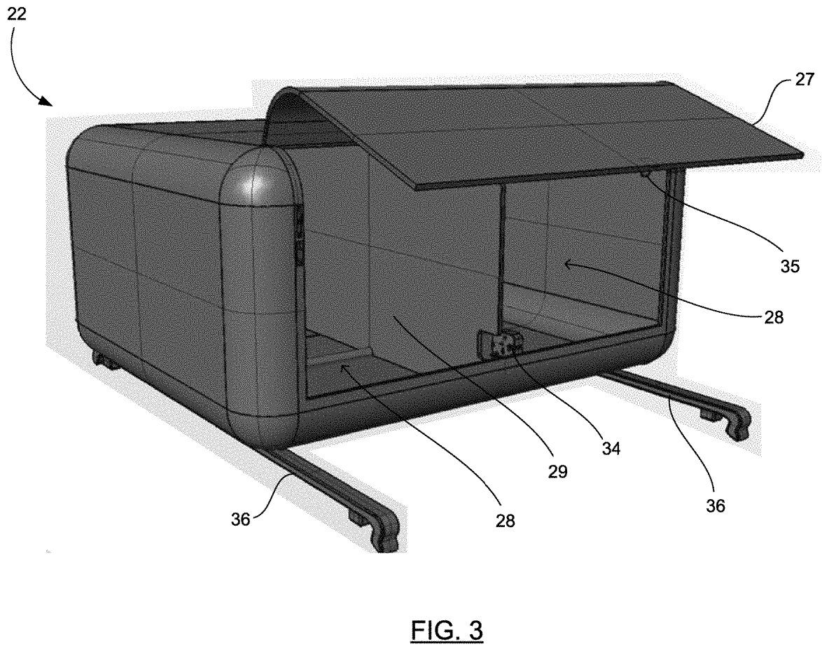

FIG. 2B is a side-view illustration of the customer 40 dropping off the package 44 to the lockbox-equipped vehicle 20, according to an embodiment of the present disclosure. The lockbox 22 includes one or more compartments 28 (shown in FIG. 3) for receiving customer packages. When the vehicle 20 arrives at the location of the customer 40, the customer 40 holds the smart phone 42 where it can be scanned by a scanner 26 on the lockbox 22. The scanner 26 reads the QR code (provided by the QWQER app) from the smart phone 42 and opens the lockbox 22 to allow the customer 40 to place the package 44 therein. At this point, the package 44 has been received into the QWQER system, and the back-end QWQER software running on the server 80 calculates how to most quickly and efficiently deliver the package 44 to its final destination.

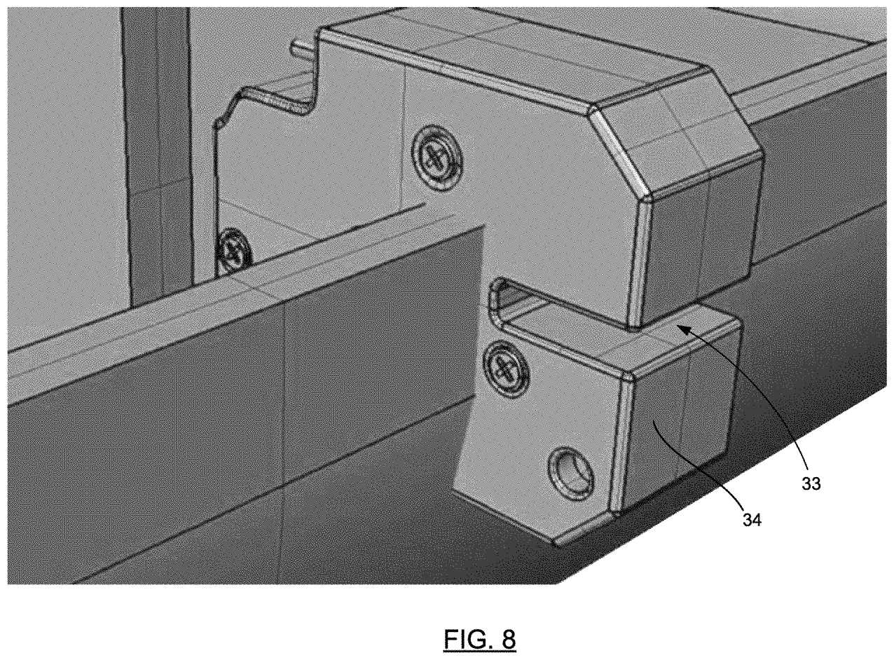

FIG. 3 is an isometric view illustration of the lockbox 22 shown in FIGS. 2A and 2B, according to an embodiment of the present disclosure. In this embodiment, the lockbox 22 has two internal compartments 28 separated by a partition 29—possibly one compartment 28 for packages being received from customers, and the other compartment 28 for packages being delivered by the driver. A door 27, secured by a latch 34, is openable to allow packages to be placed into or taken out of the compartments 28. As shown in FIG. 8, the latch 34 includes a slot 33 configured to receive a clasp 35 secured to the door 27 therein. The slot 33 includes a locking mechanism (not shown) which selectively prevents the clasp 35 from being removed from the slot 33. The locking mechanism can be a mechanical locking mechanism, a magnetic locking mechanism, or other locking mechanism as desired. The door 27 may be opened by the customer after the QWQER-provided QR code on their smart phone 42 has been scanned by the scanner 26, causing the latch 34 to release the clasp 35 from the slot 33. The driver may also have a special QR code for opening the door 27, and/or a key or tool for mechanically opening the door 27 in the event of a loss of power or malfunction of the scanner 26. In other embodiments, the driver may be prohibited or prevented from opening the lockbox 22 to provide a secure receipt, transport, and delivery of the package 44. In still other embodiments, the vehicle 20 may be autonomous, with no driver, in which case the customers 40 and 50 open and close the lockbox 22 themselves.

The lockbox 22 may be mounted on rails 36, which may be part of the vehicle 20, part of the lockbox 22, or may be separately provided. The lockbox 22 may have any size and shape suitable for mounting on a vehicle and carrying packages. In one embodiment, as shown in FIG. 3, the lockbox 22 has a length of just over one meter, a width of about 1¼ meters, and a height of a little over ½ meter. Many other sizes, shapes and configurations of the lockbox 22 are possible—including larger or smaller sizes, different numbers and sizes of the compartments 28, placement of the doors 27 on the sides or back, including more than one door 27 and possibly a separate door 27 for each of the compartments 28, etc.

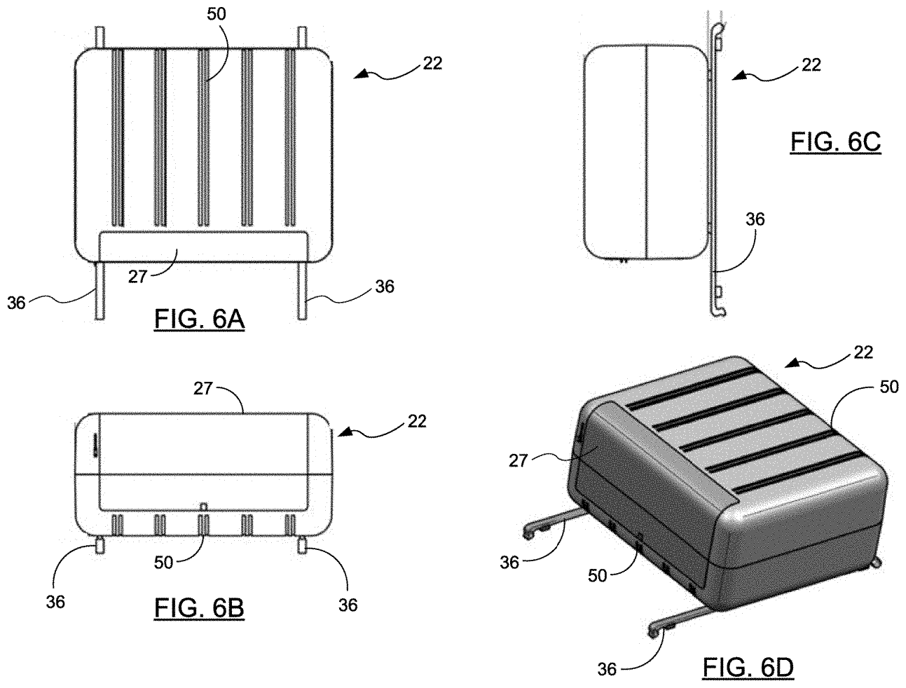

FIGS. 6A to 6D show various views of the lockbox 22. FIG. 6A is a top plan view of the lockbox 22 shown in FIG. 3. In FIG. 6B a front elevational view of the lockbox 22 of FIG. 3 is provided. FIG. 6C is a right side elevational view of the lockbox 22 of FIG. 3 rotated 90 degrees counterclockwise from the orientation shown in FIGS. 6A and 6B. FIG. 6D shows a perspective view of the lockbox 22 of FIGS. 3 and 6A-6C. A plurality of spaced apart ribs 50 can be provided on a top and a bottom of the lockbox 22 to provide reinforcement and structural rigidity to the lockbox 22. The rails 36 are also clearly shown in FIGS. 6A to 6D, as is the door 27 in a closed position.

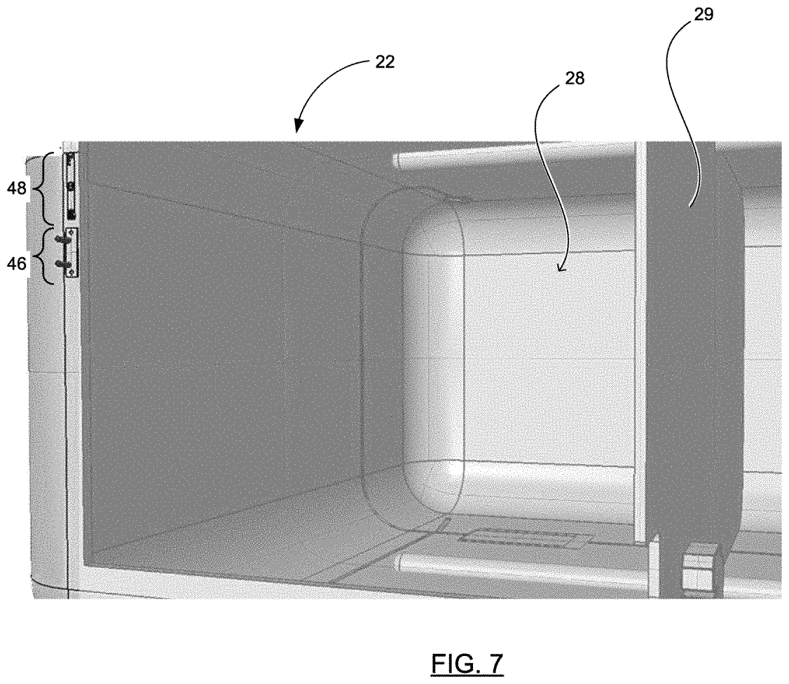

FIG. 7 is a fragmentary perspective view of the lockbox 22 of FIG. 3 showing a lock 46 and a sensor system 48. As shown, the lock 46 is an electric or electronic lock. The lock 46 may be used instead of or in combination with the controllable latch 34 discussed earlier. A sensing and capture system 48 cooperates with the lock 46 to remotely control the lock and capture a video image. The lock 46 and the sensing and capture system 48 further include a recorder such as a video camera or a camcorder, a sensor such as an infrared sensor, a router such as a 4G or other router, and a motherboard. The recorder can record a video. The sensor controls an activation of a lock control system. The router provides a connection such as an internet connection or cellular phone connection. The motherboard or controller controls the lock 46 and recorder. When an object approaches, such as within 0.5 m, for example, the sensor senses the object and switches on the recorder. The recorder is operated for a predetermined time such as three seconds for example. Further, the sensor provides a signal which causes the entire lock 46 and sensing and capture system 48 to be changed to an active state. Locking and unlocking of the lock 46 is controlled remotely such as via an IP address. Commands may be transmitted to lock and unlock or open and close the lockbox 22 via the lock 46 and the sensing and capture system 48. The commands are transmitted via the router. The sensing and capture system 48 shown in FIG. 7 is equivalent to the generically-discussed scanner 26 of FIG. 2B. As shown in FIG. 7, the sensing and capture system 48 is positioned immediately adjacent an edge of the door 27, where the camera and sensor have an unobstructed view of an area ahead of the lockbox 22. Other locations for the sensing and capture system 48 may also be used as desired.

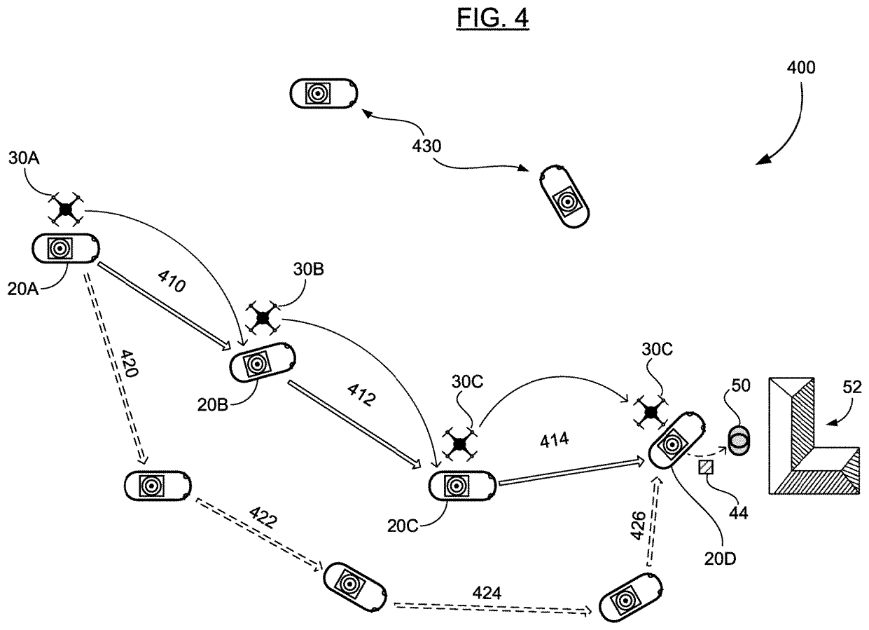

FIG. 4 is a top view illustration 400 of drone and vehicle routing in the synchronous package delivery system, according to an embodiment of the present disclosure. It should be explained that many different options exist for using the synchronous delivery system to deliver the packages 44 to their destination. One option is for the driver of one of the vehicles 20 to simply meet the sending customer at his/her location to pick up the package 44, and drive the package 44 to its final destination. This simple option provides fast and efficient delivery of packages which only need to travel a few miles or across town, especially if traffic on the roads is light. Another delivery option is for the package 44 to be drone-flown rather than vehicle-driven to the destination location. Drone-flying the package 44 is an attractive option when speed is of the essence, or when traffic on the roads is congested. Combinations of drone- and vehicle-based delivery are of course possible. Third-party delivery companies may also be used for long-haul package movement (across the country, for example), where the QWQER-based synchronous delivery system could be used for receiving packages from the sending customer and delivery to the destination location.

The scenario of FIG. 4 is that a lockbox-equipped vehicle 20A and a drone 30A are at a starting location at the left side of the figure, and the vehicle 20A has a package 44 which needs to be delivered to a customer 50 at their home 52 at the right side of the figure. In this scenario, the vehicle 20A may have just received the package 44 from the sending customer and, based on the destination location, the drone 30A is dispatched to the location of the vehicle 20A to initiate transport of the package 44 by air. Drivers of the vehicles 20 may also request a drone to be dispatched, using a request function in the QWQER app. Only some of the lockbox-equipped vehicles 20 and the drones 30 in FIG. 4 are labeled with reference numerals; the other instances of the vehicles 20 and the drones 30 have the reference numerals omitted to reduce drawing clutter.

In FIG. 4, many of the lockbox-equipped vehicles 20 are shown. These are all different vehicles, at different locations around a city. Several of the drones 30 are also shown in FIG. 4. These may all be different drones, or may be the same drone with a different battery pack installed, with the corresponding behavior being described below. In the FIG. 4 delivery scenario, the distance from the initial location at the vehicle 20A to the destination location at the home 52 is too great for the drone 30A to fly non-stop. Drone recharging stops at some of the vehicles 20 are required.

The package 44 to be delivered to the customer 50 begins at the lockbox-equipped vehicle 20A. The QWQER software, knowing the locations of all of the lockbox-equipped vehicles 20, and the location of the package destination (the home 52), calculates an optimum flight route from the vehicle 20A to the home 52. The optimum route in this case consists of segments 410, 412 and 414, involving the vehicles 20A, 20B, 20C and 20D. Another route—consisting of segments 420, 422, 424 and 426—was also considered by QWQER, but covered a longer distance and required more vehicles and more drone hops than the optimum route.

Other lockbox-equipped vehicles 20 are also known to the QWQER software. However, some of these vehicles, shown generally at 430, are located far from any practical route to the home 52, and are not included in any routing computations. Furthermore, still other vehicles 20—not shown—may be known to QWQER, but not included in the optimum routing. For example, a lockbox-equipped vehicle may be located somewhere between the vehicles 20B and 20C, but not used. This is because QWQER knows the flying range of the drones 30, and computes a route with segment lengths which consume most but not all (e.g., 75%) of the drone's battery capacity.

Based on the known vehicle locations and the drone flight range, the optimum route along the segments 410-414 has been computed by the QWQER server software. QWQER then instructs the drivers of the vehicles 20A-20D, and the drones 30A-30C, to execute the package delivery. This is done by attaching the package 44 to the drone 30A, which flies the segment 410 to the vehicle 20B. At this point, the drone 30A identifies the vehicle 20B by scanning or camera imaging of the target and the identification symbols on the landing pad 24 on top of the lockbox 22. The drone 30A communicates to the QWQER server that it is ready to land, the vehicle 20B is instructed to park if it is currently moving, and the drone 30A lands on top of the vehicle 20B.

The package 44 is then transferred to the drone 30B for the next segment 412 of the delivery journey. The transfer may be done manually by the driver of the vehicle 20B, or package handling equipment could be fitted to the lockbox 22 and the drones 30 to automate the package transfer. Alternately, instead of transferring the package 44 from one drone to another, the battery pack of the drone 30A may be swapped out for a freshly-charged battery pack by the driver of the vehicle 20B. Battery pack exchange may also be automated. Once the drone 30A has received a fresh battery pack (or even been recharged, if this can be done in a timely fashion), it becomes known as the drone 30B.

The process described above for the segment 410 is then repeated for the route segment 412, and again for the segment 414. When the drone 30C lands on the vehicle 20D, the driver of the vehicle 20D removes the package 44 from the drone 30C and delivers it to the customer 50. In this way, the package 44 covers the cross-town delivery distance entirely in the air at the speed of the drones 30, unencumbered by surface traffic conditions, and with only brief stops for battery pack or package exchange. Because the packages 44 are travelling by air, and because the logistics of pick-up, transport and delivery are entirely automated by QWQER, cross-town deliveries can be completed very quickly and efficiently.

QWQER also performs other logistics computations, such as staging of the drones 30 when they are not transporting a package from one location to another, and staging of the lockbox-equipped vehicles 20 when they are not performing a package pick-up or a package delivery.

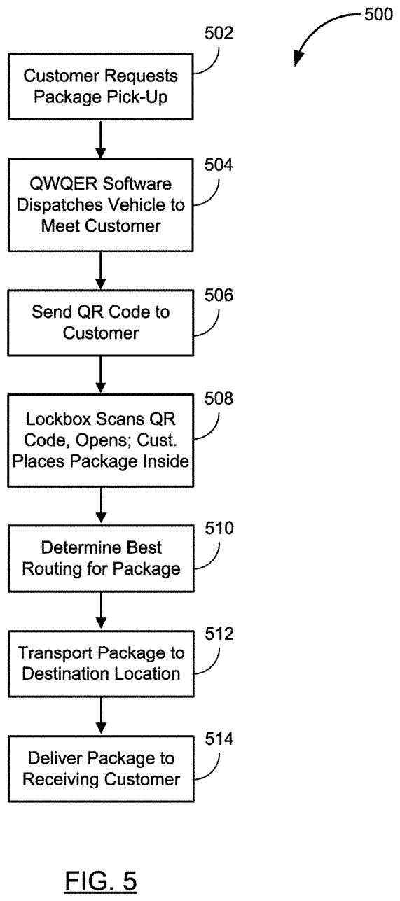

FIG. 5 is a flowchart diagram 500 of a method for pick-up and delivery of packages using a fleet of the lockbox-equipped vehicles 20 and a fleet of the drones 30. At box 502, the sending customer 40 requests package pick-up using the QWQER app on his or her smart phone 42. The customer 40 also enters the destination location for the package (such as a street address, or an identifier of a mobile device such as a phone). At box 504, the QWQER software on the server 80 arranges for one of the vehicles 20 to drive to the location of the customer 40, using location information from the customer's smart phone 42. The QWQER software may notify a particular one of the drivers 20 that he or she is instructed to drive to the customer location, or the software may post an available pick-up opportunity (and location) in the QWQER app, and a nearby one of the driver 20 can accept the job. A driverless autonomous vehicle may be dispatched by the QWQER software instead of instructions to a driver.

At box 506, the QWQER app sends a unique QR code to the smart phone 42 of the customer 40. The QR code is delivered in the QWQER app running on the smart phone 42. At box 508, the lockbox scanner 26 scans the QR code from the phone 42 and opens the lockbox 22, allowing the customer 40 to place the package 44 inside. At box 510, the QWQER software determines the best routing for the package 44 to reach the destination location. The determination of the best routing involves many factors—including minimizing time to delivery, minimizing distance travelled by the vehicles 20 and the drones 30, maximizing number of packages carried by each of the vehicles 20 as it drives along a route, etc.

At box 512, the package is transported from the origination location (the location where the driver met the customer 40) to the destination location. As described previously, the package transport may include any combination of ground travel by one or more of the vehicles 20 and flight by one or more of the drones 30. In one example, one of the drones 30 picks up the package 44 at the origination location and flies a multi-segment route (with battery pack replacement or recharge by one of the vehicles 20 at each stop) to the destination location, where the driver of one of the vehicles 20 takes the package 44 from the drone 30 and delivers it to the customer 50.

In another example of package transport, the driver of the vehicle 20 drives the package 44—either directly or indirectly—to the destination, with or without other packages also in the lockbox 22. One of the vehicles 20 could also drive the package 44 partway to its destination, and transfer the package 44 to another of the vehicles 20 which is travelling in the direction of the destination of the package 44. Transfer to third-party carriers for long-haul transport is also possible. In any case—whether transported by the vehicles 20, the drones 30 or a combination thereof—at box 514, the package 44 ends up at the destination location with one of the vehicles 20, whose driver delivers the package to the customer 50.

Throughout much of the above discussion, the vehicles 20 have been described as being driven by a driver using the QWQER app. In an alternate embodiment of the present invention, the vehicles 20 may be autonomous vehicles, and instead of a driver using the QWQER app, the autonomous vehicles 20 are directly controlled and dispatched by the QWQER software running on the server 80. In the autonomous vehicle embodiment, the lockboxes 22 would be configured to allow a customer to either place a package inside or remove a package. This is enabled by the sensing and capture system 48, the latch 34 and the lock 46 discussed previously. An automated and controllable door closure mechanism (such as those commonly used on automotive vehicle lift-gates) may also be provided in the lockbox 22.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices—including at least the server 80 running the QWQER software, the smart phones 42 running the QWQER app, and the controller or motherboard in the sensing and capture system 48—may employ various volatile and/or non-volatile memories including non-transitory computer-readable media with an executable program stored thereon including various code or executable instructions able to be performed by the computer or processor, where the memory and/or computer-readable medium may include all forms and types of memory and other computer-readable media.

While a number of exemplary aspects and embodiments for a synchronous delivery system have been discussed above, those of skill in the art will recognize modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A synchronous package delivery system, said system comprising:
one or more vehicles each including a lockbox configured for receiving and securing packages for delivery, where each vehicle is driven by a driver having a mobile device configured to run a synchronous delivery application (“app”);
one or more aerial drones each capable of carrying one or more of the packages, where each drone includes a communication system and a navigation system; and
a server computer in wireless communication with the drones and with the app on the mobile device of each of the drivers, where the server computer is configured to run a synchronous delivery program, and where the program computes a routing for each package to be transported from an origination location to a destination location, and the program computes the routing based on factors including minimizing time to delivery, minimizing distance travelled by the vehicles and the drones, maximizing a number of packages carried by each of the vehicles as it drives along a route, and ensuring that a distance of each drone flight segment is less than a maximum permissible range.

2. The system according to claim 1 wherein the lockbox is attached to a roof of each of the vehicles.

3. The system according to claim 1 wherein the lockbox includes a plurality of compartments, at least one door with a latch, and a scanner configured to read a QR code and unlatch and open the door when the QR code is valid.

4. The system according to claim 1 wherein the origination location is a location at which one of the vehicles meets a customer to pick up a package from the customer.

5. The system according to claim 4 wherein the customer at the origination location requests a package pickup using a mobile device running the app, the program communicates the origination location to one or more drivers using the app, one of the drivers accepts the package pickup request and drives to the origination location, the lockbox scans an app-provided QR code from the smart phone of the customer and unlocks a door to a compartment in the lockbox, and the customer places the package in the compartment.

6. The system according to claim 1 wherein the routing includes driving a package to the destination location by the vehicle which drove to the origination location.

7. The system according to claim 1 wherein the routing includes one of the drones picking up a package from a first one of the vehicles at the origination location and flying the package directly to the destination location, whereupon the drone lands on a second one of the vehicles and the driver of the second vehicle retrieves the package from the drone and delivers the package to a person or place at the destination location.

8. The system according to claim 7 wherein, when intermediate stops are required in the routing in order to avoid exceeding drone flight range, the drone lands on the one or more additional vehicles, and the driver of each of the one or more additional vehicles exchanges or recharges a battery pack in the drone to enable the drone to continue on the routing.

9. The system according to claim 1 wherein the routing includes using a combination of the drones and the vehicles to transport a package from the origination location to a first transfer location, where a third-party delivery service transports the package from the first transfer location to a second transfer location, and a combination of the drones and the vehicles is used to transport the package from the second transfer location to the destination location.

10. The system according to claim 1 wherein each vehicle may be online or offline at any particular time, where a vehicle online signifies that the driver of the vehicle has indicated in the app that the vehicle is available for package pick-up and delivery and for drone rendezvous.

11. A method for pick-up and delivery of packages, said method comprising:
providing one or more vehicles and one or more aerial drones for package pick-up and delivery;
requesting a pick-up of a package, by a customer using a mobile device configured to run a synchronous delivery application (“app”), where the customer also enters in the app a destination location for the package;
arranging for one of the vehicles to drive to an origination location to meet the customer, where the arranging is performed by a synchronous delivery software program running on a server computer having a processor and memory, where the server computer is in communication with the app running on any mobile device and with the aerial drones;
sending, by the synchronous delivery software program, a unique QR code to the app on the mobile device of the customer;
scanning the QR code from the mobile device, by a lockbox mounted to the vehicle which drove to the origination location, causing the lockbox to open;
placing the package inside the lockbox by the customer;
determining, by the synchronous delivery software program, a best routing for the package from the origination location to the destination location;
transporting the package from the origination location to the destination location using one or more vehicles, one or more drones, or both; and
delivering the package to a person or place at the destination location by one of the vehicles.

12. The method according to claim 11 further comprising designating each of the vehicles in the fleet of vehicles as online or offline, by a driver of each of the vehicles using a mobile device configured to run the synchronous delivery app, where online means that a driver of the vehicle has indicated in the app that the vehicle is available for package pick-up and delivery and for drone rendezvous.

13. The method according to claim 12 wherein arranging for one of the vehicles to drive to the origination location includes posting a package pick-up job in the app where a driver of one of the online vehicles can accept the job.

14. The method according to claim 12 wherein arranging for one of the vehicles to drive to the origination location includes instructing a driver of one of the online vehicles to drive to the origination location.

15. The method according to claim 11 wherein arranging for one of the vehicles to drive to the origination location includes providing instructions from the synchronous delivery software program to an autonomous vehicle which drives to the origination location and receives the package from the customer.

16. The method according to claim 11 wherein the lockbox includes a plurality of compartments, a door with a latch, and a scanner configured to read the QR code and unlatch and open the door when the QR code is valid.

17. The method according to claim 11 wherein determining a best routing for the package includes considering minimizing time to delivery, minimizing distance travelled by the vehicles and the drones, maximizing a number of packages carried by each of the vehicles as it drives along a route, and ensuring that a distance of each drone flight segment is less than a maximum permissible range.

18. The method according to claim 11 wherein transporting the package from the origination location to the destination location includes driving the package to the destination location by the vehicle which drove to the origination location.

19. The method according to claim 11 wherein transporting the package from the origination location to the destination location includes one or more drone flight segments, where a drone flight segment comprises one of the drones picking up the package from a first one of the vehicles and flying to a rendezvous point to land on a second one of the vehicles, whereupon the driver of the second one of the vehicles either takes receipt of the package or re-energizes the drone by replacing or recharging a battery pack in the drone.

20. The method according to claim 11 wherein transporting the package from the origination location to the destination location includes using a combination of the drones and the vehicles to transport the package from the origination location to a first transfer location, where a third-party delivery service transports the package from the first transfer location to a second transfer location, and a combination of the drones and the vehicles is used to transport the package from the second transfer location to the destination location.
